(19) United States
(12) Patent Application Publication
(10) Pub. No.: US 2007/0285387 A1
(43) Pub. Date: Dec. 13, 2007

(54) OUTPUT PROPERTY ADJUSTING APPARATUS AND OUTPUT PROPERTY ADJUSTING METHOD

(75) Inventors: Hua-Dong Cheng, Shenzhen City (CN); Han-Che Wang, Shenzhen City (CN); Feng Zhou, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/759,943

(22) Filed: Jun. 8, 2007

(30) Foreign Application Priority Data
Jun. 9, 2006 (CN) 200610061070.3

(51) Int. Cl. G09G 5/00

(52) U.S. Cl. 345/156

(57) ABSTRACT

An exemplary output property adjusting apparatus includes a first display area, a second display area, a third display area, a scroll bar, and a micro controller unit (MCU). The first display area is for displaying data files. The second display area is for displaying output properties in a property select mode. The third display area is for displaying at least two adjustable attribute values of a selected output property in a property adjust mode. The MCU applies the selected adjustable attribute value to the selected output property, in response to adjustment operational inputs through the scroll bar. A related output property adjusting method is also provided.

### BACKGROUND

1. Technical Field

The present invention relates to an output property adjusting apparatus typically used to change characteristics of electronic information presented to a user in the form of a visual display or sound, and a method for adjusting output properties of a device that incorporates the output property adjusting apparatus.

2. General Background

Adjusting the output properties of various electronic devices such as PDAs (Personal Digital Assistants), mobile phones, and mp3 (MPEG, audio layer 3) players is an important feature for users. The output properties relate to characteristics such as font size, brightness, and audio volume. Typically, adjusting output properties involves switching from a current screen that displays a running application to a special menu screen, and then choosing and adjusting the output properties. If the electronic device is a single-process device that can only run one application at one time, the application running currently needs to be terminated so as to enter an adjusting mode. This can be troublesome and inconvenient.

What is needed, therefore, is an output property adjusting apparatus and a method which can overcome the above-described shortcomings.

### SUMMARY

An output property adjusting apparatus is provided. The apparatus includes: a display unit, wherein the display unit includes a first display area, a second display area and a third display area, the third display area is adjacent the second display area; a storage unit configured for storing data files, and output properties of the output property adjusting apparatus, wherein the output properties control at least one of an appearance and a sound of at least one selected of the data files outputted from the output property adjusting apparatus in the form of at least one of a visual presentation and an audio presentation, and each of the output properties has at least two adjustable attribute values; an input unit configured for receiving operational inputs; and a micro controller unit (MCU).

The MCU includes a first control module configured for reading the at least one selected data file from the storage unit, and outputting the at least one selected data file at least one of the first display area and an audio output device; a second control module configured for reading the output properties from the storage unit, displaying the output properties in the second display area in a property select mode of the output property adjusting apparatus, and displaying the adjustable attribute values of the selected output property in the third display area in a property adjust mode of the output property adjusting apparatus; a property selection module configured for selecting an output property from the output properties displayed in the second display area, the selecting being in response to an operational input received by the input unit in the property adjust mode; a scroll module configured for displaying a scroll bar in the third display area, scrolling through the output properties displayed in the second display area according to at least one operational input performed on the scroll bar in the property select mode, and selecting an adjustable attribute value of the selected output property displayed in the third display area, the selecting being in response to an operational input performed on the scroll bar in the property adjust mode; a switch mode module configured for switching between the property select mode and the property adjust mode; and an apply property module configured for applying the selected adjustable attribute value to the selected output property via the first control module.

A method for adjusting output properties of an electronic device is also provided. The electronic device includes a first display area, a second display area, a third display area, a scroll bar, and a storage unit. The storage unit stores data files, and output properties of the electronic device, the output properties control at least one of an appearance and a sound of at least one selected of the data files outputted from the electronic device in the form of a visual or audio presentation, and each of the output properties has at least two adjustable attribute values. The method includes: reading the at least one selected data file, and outputting the at least one selected data file at least one of the first display area and an audio output device; reading the output properties, and displaying the read output properties in the second display area, in a property select mode of the electronic device; scrolling through the output properties displayed in the second display area according to at least one operational input performed on the scroll bar, in the property select mode; selecting an output property from the output properties displayed in the second display area, in the property select mode; switching to a property adjust mode of the electronic device; displaying the adjustable attribute values of the selected output property in the third display area in the property adjust mode; selecting an adjustable attribute value of the selected output property displayed in the third display area, the selecting being in response to an operational input performed on the scroll bar, in the property adjust mode; and applying the selected adjustable attribute value to the selected output property via the first control module.

An electronic device is further provided. The electronic device includes: output means including at least one of a display unit and an audio output unit, wherein the display unit includes a first display area, a second display area and a third display area, the third display area is adjacent the second display area; a storage unit configured for storing data files, and output properties of the electronic device, wherein the output properties control at least one of an appearance and a sound of at least one selected of the data files outputted from the electronic device in the form of at least one of a visual presentation and an audio presentation, and each of the output properties has at least two adjustable attribute values; an input unit configured for receiving operational inputs; and a micro controller unit (MCU).

The MCU includes a first control module configured for reading the at least one selected data file from the storage unit, and outputting the at least one selected data file at least one of the first display area and the audio output unit; a second control module configured for reading the output properties from the storage unit, displaying the output properties in the second display area in a property select mode of the electronic device, and displaying the adjustable attribute values of the selected output property in the third display area in a property adjust mode of the electronic device; a property selection module configured for selecting an output property from the output properties displayed in the second display area, the selecting being in response to an operational input received by the input unit in the property adjust mode; a scroll module configured for displaying a scroll bar in the third display area, scrolling through the output properties displayed in the second display area according to at least one operational input performed on the scroll bar in the property select mode, and selecting an adjustable attribute value of the selected output property displayed in the third display area, the selecting being in response to an operational input performed on the scroll bar in the property adjust mode; a switch mode module configured for switching between the property select mode and the property adjust mode; and an apply property module configured for applying the selected adjustable attribute value to the selected output property via the first control module.

In summary, the output property adjusting apparatus and method enable output properties to be adjusted in one display area of an electronic device while a running application remains displayed in another display area of the electronic device.

Other novel features and advantages will be drawn from the following detailed description with reference to the attached drawings, in which:

### BRIEF DESCRIPTION OF THE DRAWINGS

FIG. 1 is a block diagram of hardware infrastructure of an output property adjusting apparatus in accordance with a preferred embodiment of the present invention;

FIG. 2 is a schematic diagram of a display unit of the apparatus of FIG. 1, the display unit including a first display area and a second display area, and showing the second display area in a property select mode;

FIG. 3 is similar to FIG. 2, but showing the second display area in a property adjust mode;

FIG. 4 is similar to FIGS. 2 and 3, but only showing a first display area of the display unit, with the second display area in a first hidden mode in which the second display area itself is hidden;

FIG. 5 is similar to FIG. 4, but showing the second display area in a second hidden mode in which adjustable attribute values of output properties displayed in the second display area are hidden; and

FIG. 6 is a flowchart of a preferred method for adjusting output properties of the apparatus of FIG. 1.

### DETAILED DESCRIPTION OF THE EMBODIMENTS

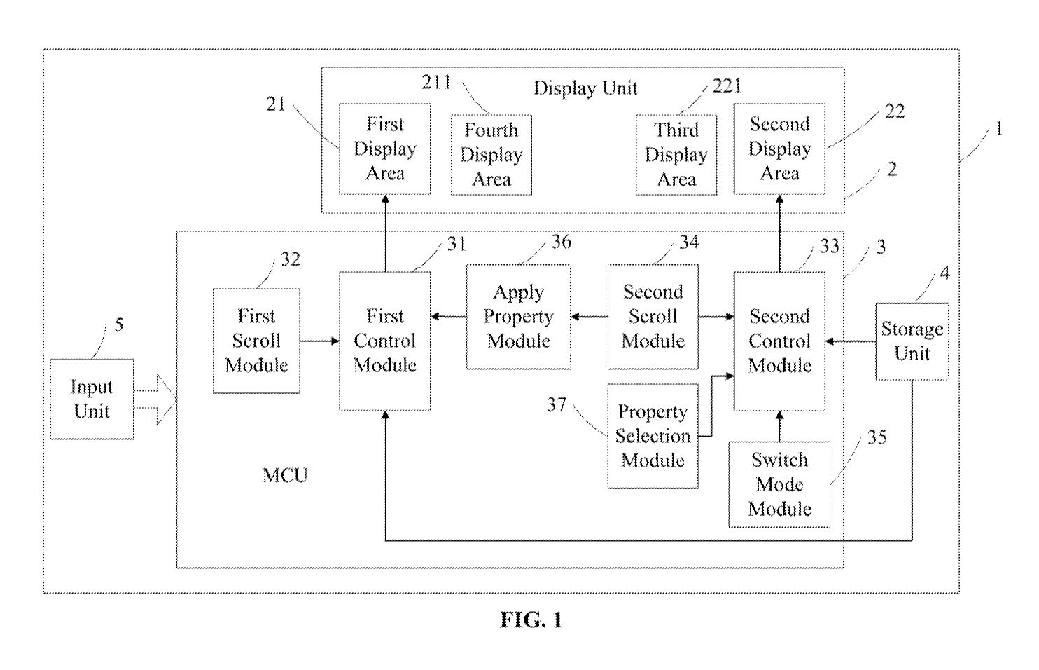

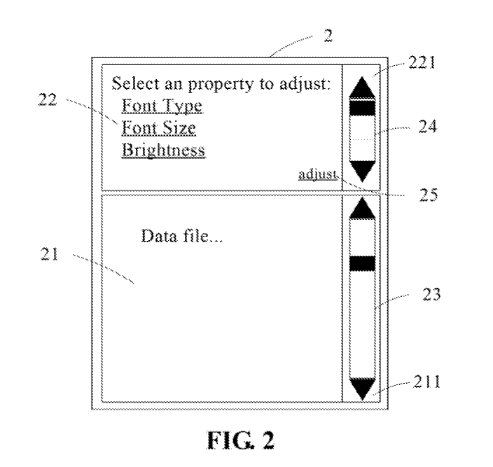

FIG. 1 is a schematic diagram of hardware infrastructure of an output property adjusting apparatus in accordance with an exemplary embodiment of the present invention. The output property adjusting apparatus 1 includes a display unit 2, a micro controller unit (MCU) 3, a storage unit 4, and an input unit 5. Typically, the output property adjusting apparatus 1 forms part of an electronic device such as a PDA, a mobile phone, or an mp3 player. In the exemplary embodiment, referring also to FIG. 2, the display unit 2 includes a first display area 21, a second display area 22, a third display area 221, and a fourth display area 211. The third display area 221 and the fourth display area 211 are positioned along a side of the second display area 22 and the first display area 21 respectively. The storage unit 4 is configured for storing data files and output properties. The data files may be text files, image files, audio files, video files, and so on. The output properties control an appearance or sound of the data files as outputted from the output property adjusting apparatus 1 in the form of a visual or audio presentation. The output properties can, for example, be font size and font type of text, brightness and contrast of the display unit 2, volume of a playing audio file, and so on. In the following description of the exemplary embodiment, for convenience, only output properties in relation to a visual presentation are discussed. It is to be understood that in further and/or alternative embodiments, output properties in relation to an audio presentation can also be appropriately handled. For example, the electronic device can include an audio output device such as a speaker. Further, for convenience, only ‘Font Type’, ‘Font Size’, and ‘Brightness’ output properties are shown in the drawings and described in detail below. Each of the output properties has at least two adjustable attribute values. For example, the “Font Size” has a group of adjustable attribute values ‘1’, ‘2’, and ‘3’. The input unit 5 is configured for receiving operational inputs from a user. The input unit 5 can for example be a touchpad, a keypad, or a pointing device such as a mouse.

The MCU 3 includes a first control module 31, a second control module 33, a first scroll module 32, a second scroll module 34, a switch mode module 35, a property selection module 37, and an apply property module 36. The first control module 31 is configured for reading the data file(s) from the storage unit 4, and displaying the data file(s) in the first display area 21. The first scroll module 32 is configured for displaying a first scroll bar 23 in the fourth display area 211 along the side of the first display area 21, and scrolling through displayed data file(s) according to operations performed on the first scroll bar 23 by the user through the input unit 5.

Selectable modes of each of the second control module 33 and the second scroll module 34 include a property select mode, a property adjust mode, and a hidden mode. In the property select mode, the second control module 33 reads output properties from the storage unit 4, and displays the output properties in the second display area 22 (see FIG. 2). The second scroll module 34 displays a second scroll bar 24 in the third display area 221 along the side of the second display area 22. The second scroll module 34 can scroll through the displayed output properties in the second display area 22 according to operations performed on the second scroll bar 24 by the user through the input unit 5.

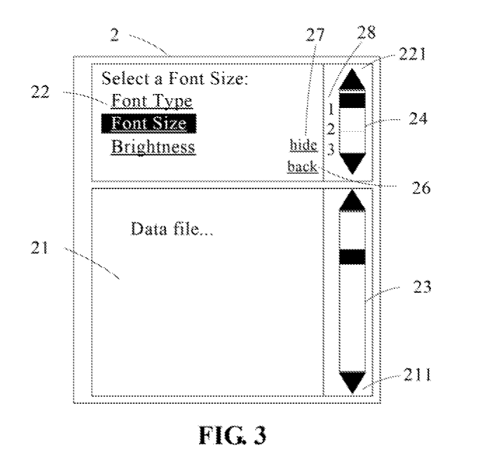

The property selection module 37 is configured for selecting one of the output properties displayed in the second display area 22 according to operations performed on an adjust button 25 by the user. After an output property is selected, the switch mode module 35 switches the mode of the second control module 33 and the second scroll module 34 from the property select mode to the property adjust mode, and the second control module 33 highlights the selected output property, as shown in FIG. 3.

In the property adjust mode, the second control module 33 further displays a group of adjustable attribute values 28 of the selected output property in the third display area 221. The adjustable attribute values 28 are displayed adjacent the second scroll bar 24. The second scroll module 34 can select a new value of the selected output property according to an operation performed on the second scroll bar 24 by the user through the input unit 5. The apply property module 36 applies the new value to the selected output property, whereby the appearance (or sound) of the outputted data file(s) is changed accordingly by the first control module 31. For example, when the second scroll bar 24 is scrolled to select “Font Size” to be adjusted in the property select mode, the switch mode module 35 switches to the property adjust mode, and the second control module 33 displays a group of adjustable attribute values 28 of the “Font Size” (e.g., ‘1’, ‘2’ and ‘3’), adjacent the second scroll bar 24 in the third display area 221. Then when the second scroll bar 24 is scrolled to select the new adjustable attribute value (e.g., ‘2’) in the property adjust mode, the apply property module 36 applies the adjustable attribute value ‘2’ to the font size of the outputted data file(s).

The switch mode module 35 can switch the mode of the second control module 33 and the second scroll module 34 from the property adjust mode back to the property select mode. This is achieved by the user selecting a back button 26 in the second display area 22 through the input unit 5.

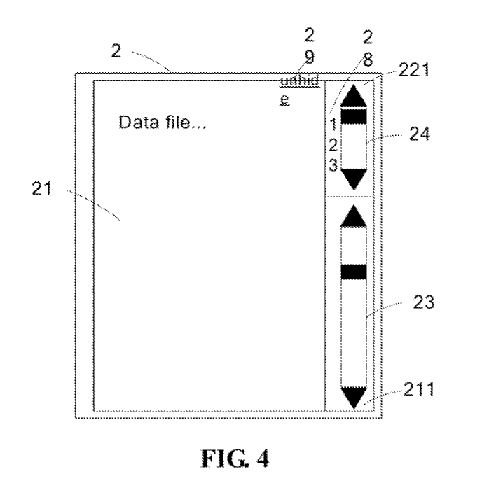

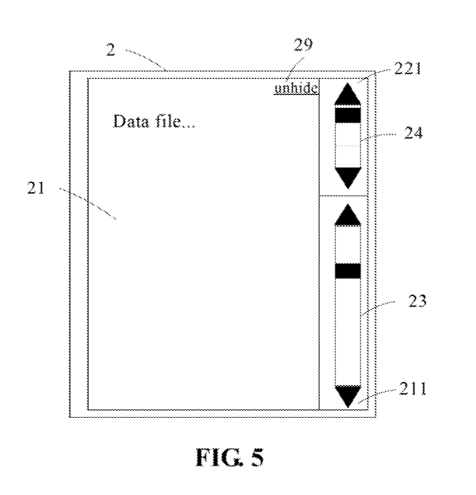

In addition, the switch mode module 35 can switch the mode of the second control module 33 and the second scroll module 34 from the property adjust mode to a hidden mode. This is achieved by the user selecting a hide button 27 in the second display area 22, or automatically if no operations are received from the input unit 5 after a predetermined period of time has elapsed since a last operation received from the input unit 5. In the hidden mode, the second control module 33 hides the second display area 22 (see FIG. 4). Thus the first control module 31 expands the first display area 21 to cover substantially a full extent of the display unit 2 including the part of the display unit 2 previously occupied by the second display area 22. However, the adjustable attribute values 28 and the second scroll bar 24 remain visible. In a further or alternative embodiment, the resulting display is the same, except that the second control module 33 further hides the adjustable attribute values 28 displayed in the third display area 221 (see FIG. 5). In either case, in the hidden mode, the previously selected output property can still be adjusted by the user through scrolling the second scroll bar 24. Further, the switch mode module 35 can switch back to the property adjust mode according to an operation performed on an unhide button 29 by the user.

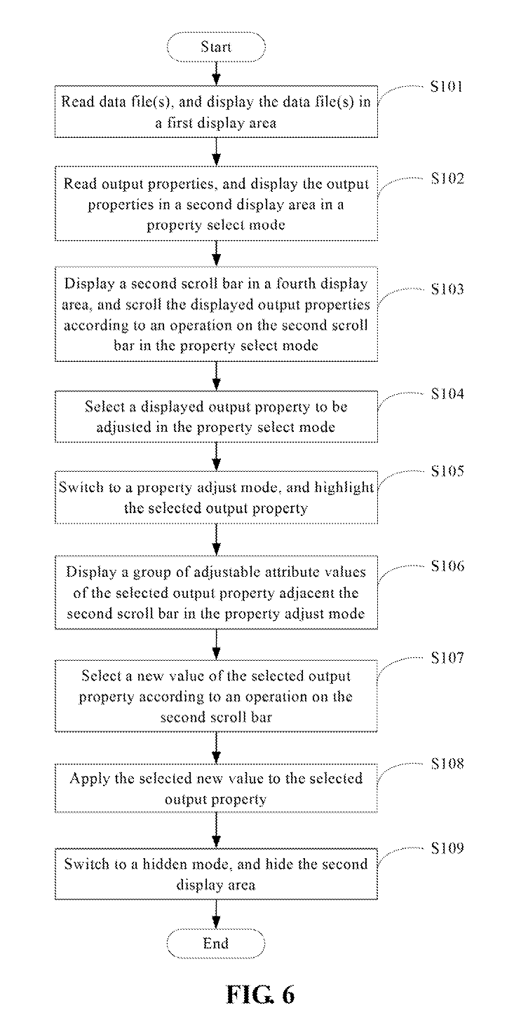

FIG. 6 is a flowchart of an exemplary method for adjusting output properties of the output property adjusting apparatus 1.

In step S101, the first control module 31 reads the data file(s) from the storage unit 4, and displays the data file(s) read in the first display area 21.

In step S102, the second control module 33 reads the output properties from the storage unit 4, and displays the output properties in the second display area 22 in the property select mode.

In step S103, the second scroll module 34 displays the second scroll bar 24 in the third display area 221 along the side of the second display area 22. Further, the second scroll module 34 scrolls the displayed output properties according to an operation performed on the second scroll bar 24 in the property select mode.

In step S104, the property selection module 37 selects a displayed output property to be adjusted in the property select mode, in response to an operation performed on the adjust button 25 in the second display area 22 through the input unit 5.

In step S105, the switch mode module 35 switches to the property adjust mode, and the second control module 33 highlights the selected output property.

In step S106, the second control module 33 displays the adjustable attribute values 28 of the selected output property in the third display area 221 and adjacent the second scroll bar 24 in the property adjust mode.

In step S107, the second scroll module 34 selects a new value of the selected output property according to an operation performed on the second scroll bar 24.

In step S108 the apply property module 36 applies the selected new value to the selected output property.

In step S109, the switch mode module 35 switches to the hidden mode, and the second control module 33 hides the second display area 22. This hiding may or may not include hiding the adjustable attribute values 28 (see above). This step occurs according to an operational input performed on the hide button 27 through the input unit 5, or after a predetermined period of time has elapsed during which no operational input is received from the input unit 5.

In summary, by utilizing the output property adjusting apparatus 1, output properties can be adjusted in the second display area 22 while a running application remains displayed in the first display area 21.

In the above descriptions, for convenience, only output properties in relation to a visual presentation have been discussed. It is to be understood that in further and/or alternative embodiments, output properties in relation to an audio presentation can also be appropriately configured and handled. For example, the electronic device can include an audio output device such as a speaker.

Further, even though preferred and exemplary embodiments including preferred and exemplary methods have been specifically described above, the present invention is not to be construed as being limited thereto. Various changes or modifications may be made to the embodiments including the methods without departing from the scope and spirit of the invention as set forth in the claims.

What is claimed is:

1. An output property adjusting apparatus, comprising:
a display unit comprising a first display area, a second display area, and a third display area, wherein the third display area is adjacent the second display area;
a storage unit configured for storing data files, and output properties of the output property adjusting apparatus, wherein the output properties control at least one of an appearance and a sound of at least one selected of the data files outputted from the output property adjusting apparatus in the form of at least one of a visual presentation and an audio presentation, and each of the output properties has at least two adjustable attribute values;
an input unit configured for receiving operational inputs from a user; and
a micro controller unit (MCU), comprising:
a first control module configured for reading the at least one selected data file from the storage unit, and outputting the at least one selected data file at least one of the first display area and an audio output device;
a second control module configured for reading the output properties from the storage unit, displaying the output properties in the second display area in a property select mode of the output property adjusting apparatus, and displaying the adjustable attribute values of the selected output property in the third display area in a property adjust mode of the output property adjusting apparatus;
a property selection module configured for selecting an output property from the output properties displayed in the second display area, the selecting being in response to an operational input received by the input unit in the property adjust mode;
a scroll module configured for displaying a scroll bar in the third display area, scrolling through the output properties displayed in the second display area according to at least one operational input performed on the scroll bar in the property select mode, and selecting an adjustable attribute value of the selected output property displayed in the third display area, the selecting being in response to an operational input performed on the scroll bar in the property adjust mode;
a switch mode module configured for switching between the property select mode and the property adjust mode; and
an apply property module configured for applying the selected adjustable attribute value to the selected output property via the first control module.

2. The apparatus according to claim 1, wherein the second control module is further configured for hiding the second display area, whereupon the first control module expands the first display area to cover substantially a full extent of the display unit including the part of the display unit previously occupied by the second display area, the hiding being in response to an operational input received by the input unit in the property adjust mode or occurring automatically after a predetermined period of time has elapsed since a last operation was received by the input unit.

3. The apparatus according to claim 2, wherein when the second display area is hidden, the second control module hides the adjustable attribute values displayed in the third display area.

4. The apparatus according to claim 2, wherein when the second display area is hidden, the second control module leaves the adjustable attribute values displayed in the third display area.

5. A method for adjusting output properties of an electronic device, wherein the electronic device comprises a first display area, a second display area, a third display area, a scroll bar, and a storage unit, the storage unit stores data files, and output properties of the electronic device, the output properties control at least one of an appearance and a sound of at least one selected of the data files outputted from the electronic device in the form of a visual or audio presentation, and each of the output properties has at least two adjustable attribute values, the method comprising:
reading the at least one selected data file, and outputting the at least one selected data file at least one of the first display area and an audio output device;
reading the output properties, and displaying the read output properties in the second display area, in a property select mode of the electronic device;
scrolling through the output properties displayed in the second display area according to at least one operational input performed on the scroll bar, in the property select mode;
selecting an output property from the output properties displayed in the second display area, in the property select mode;
switching to a property adjust mode of the electronic device;
displaying the adjustable attribute values of the selected output property in the third display area, in the property adjust mode;
selecting an adjustable attribute value of the selected output property displayed in the third display area, the selecting being in response to an operational input performed on the scroll bar, in the property adjust mode; and
applying the selected adjustable attribute value to the selected output property via the first control module.

6. The method according to claim 5, further comprising:
hiding the second display area, and expanding the first display area to cover substantially a full extent of areas previously occupied by the first display area and the second display area, in response to an operational input performed on the electronic device or automatically after a predetermined period of time has elapsed since a last operational input was performed on the electronic device.

7. The method according to claim 6, further comprising:
hiding the adjustable attribute values displayed in the third display area, when the second display area is hidden.

8. The method according to claim 6, further comprising:
leaving the adjustable attribute values displayed in the third display area, when the second display area is hidden.

9. An electronic device, comprising:
output means, the output means comprising at least one of a display unit and an audio output unit, the display unit comprising a first display area, a second display area, and a third display area, wherein the third display area is adjacent the second display area;
a storage unit configured for storing data files, and output properties of the electronic device, wherein the output properties control at least one of an appearance and a sound of at least one selected of the data files outputted from the electronic device in the form of at least one of a visual presentation and an audio presentation, and each of the output properties has at least two adjustable attribute values;
an input unit configured for receiving operational inputs from a user; and
a micro controller unit (MCU), comprising:
a first control module configured for reading the at least one selected data file from the storage unit, and outputting the at least one selected data file at least one of the first display area and the audio output unit;
a second control module configured for reading the output properties from the storage unit, displaying the output properties in the second display area in a property select mode of the electronic device, and displaying the adjustable attribute values of the selected output property in the third display area in a property adjust mode of the electronic device;
a property selection module configured for selecting an output property from the output properties displayed in the second display area, the selecting being in response to an operational input received by the input unit in the property adjust mode;
a scroll module configured for displaying a scroll bar in the third display area, scrolling through the output properties displayed in the second display area according to at least one operational input performed on the scroll bar in the property select mode, and selecting an adjustable attribute value of the selected output property displayed in the third display area, the selecting being in response to an operational input performed on the scroll bar in the property adjust mode;
a switch mode module configured for switching between the property select mode and the property adjust mode; and
an apply property module configured for applying the selected adjustable attribute value to the selected output property via the first control module.

10. The electronic device according to claim 9, wherein the second control module is further configured for hiding the second display area, whereupon the first control module expands the first display area to cover substantially a full extent of the display unit including the part of the display unit previously occupied by the second display area, the hiding being in response to an operational input received by the input unit in the property adjust mode or occurring automatically after a predetermined period of time has elapsed since a last operation was received by the input unit.

11. The electronic device according to claim 10, wherein when the second display area is hidden, the second control module hides the adjustable attribute values displayed in the third display area.

12. The electronic device according to claim 10, wherein when the second display area is hidden, the second control module leaves the adjustable attribute values displayed in the third display area.

13. The electronic device according to claim 9, wherein the audio output unit comprises a speaker.
